(19) United States
(12) Patent Application Publication
(10) Pub. No.: US 2023/0077533 A1
(43) Pub. Date: Mar. 16, 2023

(54) INJECTION NOZZLE FOR INJECTING FUEL UNDER HIGH PRESSURE

(71) Applicant: Robert Bosch GmbH, Stuttgart (DE)

(72) Inventors: Fabian Wolf, Renningen (DE); Christiane Schiedt, Waiblingen (DE); Ferdinand Nicolai, Stuttgart (DE); Gerhard Suenderhauf, Tiefenbronn (DE); Michael Leukart, Dusslingen (DE)

(21) Appl. No.: 17/786,861

(22) PCT Filed: Dec. 8, 2020
(86) PCT No.: PCT/EP2020/085101

§ 371 Date: Nov. 28, 2022

(30) Foreign Application Priority Data
Dec. 18, 2019 (DE) 10 2019 220 072.9

(51) Int. Cl. F02M 61/18; F02M 61/06

(52) U.S. Cl. CPC F02M 61/1873; F02M 61/06; F02M 61/1866; F02M 61/1893

(57) ABSTRACT

The invention relates to an injection nozzle for injecting fuel under high pressure, comprising a nozzle body (2) in which a pressure chamber (9), which can be filled with fuel under high pressure, is formed and in which a conical body seat (25) is formed which opens into a blind hole (32), forming a transition edge (35), from which blind hole a plurality of injection holes (30) originate and the total of the flow cross-sections of all injection holes forms a total injection hole cross-section (A_{SL}). A nozzle needle (14) is arranged in the pressure chamber (9) so as to be longitudinally movable, said nozzle needle interacting, by means of a conical sealing surface (27), with the body seat (25) in order to open and close a flow cross-section, wherein the nozzle needle (14) has, on the end thereof facing the body seat (25), a needle tip (28) which protrudes into the blind hole (32) when the sealing surface (27) contacts the body seat (25). A seat cross-section area (A_{S}) is formed between the sealing surface (27) and the transition edge (35) when the nozzle needle (14) is raised from the body seat (25), through which seat cross-section area fuel can flow from the pressure chamber (9) into the blind hole (32). The needle tip (28) is conical and has an opening angle (13) that is smaller than the opening angle (a) of the conical sealing surface (27), and the blind hole (32) has a conical portion (132) having an opening angle (a) that is formed between the transition edge (35) and an intermediate edge (36), wherein the needle tip (28) is arranged in a partial stroke of the nozzle needle (14) at the height of the conical portion (132) of the blind hole (32).

### BACKGROUND OF THE INVENTION

The invention relates to an injection nozzle for injecting fuel under high pressure, as is used for example in order to introduce fuel under high pressure into a combustion chamber of an internal combustion engine.

Injection nozzles for introducing fuel under high pressure have been known for a long time in the prior art. Such injection nozzles preferably form a part of a fuel injector which is electrically controlled and which is able to introduce highly compressed fuel into a combustion chamber of an internal combustion engine. The fuel is finely atomized when injected into the combustion chamber so that a combustible fuel-air mixture is produced therein. In the case of self-igniting internal combustion engines, this fuel-air mixture is ignited by compressing the fuel-air mixture in the combustion chamber and combusts with high efficiency due to the effective atomization of the fuel.

The injection nozzle, in which the injection holes are located and through which the fuel ultimately exits, controls the opening and closing of these injection openings via a piston-shaped, longitudinally displaceable nozzle needle which is arranged in the nozzle body of the injection nozzle. In this case, the movement of the nozzle needle is generally carried out hydraulically, i.e. the closing force is generated by the hydraulic pressure in a control chamber. By regulating the pressure in this control chamber and driven by the hydraulic pressure of the fuel which surrounds the nozzle needle, a longitudinal movement of the nozzle needle may be controlled. In this case, the pressure in the control chamber is controlled, for example, by an electromagnetic valve, so that the injection may be ultimately controlled in an accurate manner by the electromagnet.

The nozzle needle has a conical sealing surface at the end thereof facing the injection openings. The nozzle needle interacts, by means of this sealing surface, with a body seat which is configured in the injection nozzle in order to open and close a flow cross-section. In the case of the type of injection nozzles considered here, a blind hole which is configured as a blind bore, and from which the actual injection openings emerge, adjoins the conical body seat. The blind hole serves primarily to supply all of the injection openings with the same quantity of fuel and thus to ensure an even combustion.

If the nozzle needle is in the closed position thereof, i.e. in contact with the body seat, it closes the blind hole and thus also the injection openings relative to the pressure chamber which is filled with compressed fuel and surrounds the nozzle needle. At the start of the opening stroke of the nozzle needle, the gap between the sealing surface and the body seat represents the narrowest cross-section which limits the flow of fuel into the blind hole. The fuel which flows through this gap passes into the blind hole, where due to the significantly larger flow cross-section it leads to a pressure drop and to a deceleration of the flow. This promotes the formation of vortex structures in the fuel flow and a change from a laminar flow to a turbulent flow. Moreover, when the fuel enters the blind hole the pressure drop promotes the formation of cavitation bubbles which subsequently implode and may lead to damage on the sealing surface of the nozzle needle and on the body seat.

Different requirements have to be considered during fuel injection. Firstly, an increasingly high injection pressure is desired, since a high injection pressure brings about an effective atomization of the fuel and thus a good combustion process. At the same time, a high fuel flow rate is also intended to be made possible in order to generate high power (downsizing), i.e. in order to obtain as much power as possible with a given cubic volume. This leads, however, to nozzle geometries which promote the formation of cavitation and thus the resulting cavitation erosion.

A large total injection hole cross-section, i.e. the total cross-sections of all of the injection openings, causes the gap between the sealing surface and the body seat to form the smallest flow cross-section over a relatively large needle stroke, which correspondingly extends the time in which cavitation may occur. A large blind hole surface area also has a disadvantageous effect, i.e. a blind hole with a large flow cross-section within the blind hole which leads to the injection openings, since the pressure drop is increased thereby with the inflow of the fuel into the blind hole and the formation of cavitation is promoted. A large-volume blind hole also assists the formation of turbulence which extends the dwell time of the cavitation bubbles inside the blind hole and increases the probability that these cavitation bubbles will implode and lead to damage therein.

An injection nozzle for introducing fuel into a combustion chamber of an internal combustion engine, which operates according to the principle set forth above, is disclosed in EP 1 891 324 B1. The nozzle needle has a conical sealing surface which interacts with a body seat, which is also conical, in order to open and close a flow cross-section. A nozzle tip is configured on the nozzle needle, said nozzle tip partially protruding into the blind hole of the injection nozzle. The transition of the conical sealing surface to the needle tip is configured to be rounded so that, starting from the gap between the sealing surface and the body seat, the flow cross-section widens relatively quickly and thus the above-described pressure drop takes place even before the entry of fuel into the blind hole.

An injection nozzle of this type is also disclosed in DE 10 2005 037 955 A1 in which the sealing surface has a significantly different cone angle from that of the body seat, so that the bearing of the sealing surface with the body seat takes place substantially over a circumferential sealing edge. A further narrow cross-section is formed between a second part of the sealing surface and the edge which is configured at the transition of the body seat to the blind hole, so that the flow here flows unevenly from a region with a high flow velocity into a region with a low flow velocity and then again in a region with a high flow velocity.

### SUMMARY OF THE INVENTION

The injection nozzle according to the invention accordingly has the advantage that cavitation formation in the injection nozzle, in particular below the sealing seat and in the blind hole, is prevented or reduced to a level which eliminates damaging cavitation erosion. As a result, the service life of the fuel injection valve and the precision of the injection is also improved over a longer service life. To this end, the injection nozzle comprises a nozzle body in which a pressure chamber, which can be filled with fuel under high pressure, is formed and in which a conical body seat is formed. The conical body seat transitions into a blind hole, forming a transition edge, from which blind hole a plurality of injection holes originate, wherein the total of the flow cross-sections of all injection holes forms a total injection hole cross-section. A nozzle needle is arranged in the pressure chamber so as to be longitudinally movable, said nozzle needle interacting, by means of a conical sealing surface, with the body seat in order to open and close a flow cross-section, wherein the nozzle needle has, on the end thereof facing the body seat, a needle tip which protrudes into the blind hole when the sealing surface contacts the body seat. In this case, a seat cross-section area is formed between the sealing surface and the transition edge when the nozzle needle is raised from the body seat, fuel being able to flow therethrough from the pressure chamber into the blind hole. The needle tip is conical and has an opening angle that is smaller than the opening angle of the conical sealing surface, and a conical portion having an opening angle which adjoins the transition edge is formed in the blind hole, wherein the needle tip is arranged in a partial stroke of the nozzle needle at the height of the conical portion of the blind hole.

By the shaping of the injection nozzle according to the invention, in particular the nozzle needle in the region of the sealing surface, a flow cross-section is formed between the nozzle needle or the nozzle needle tip and the blind hole, said flow cross-section being substantially constant and in particular in the partial stroke region of the nozzle needle, i.e. at the start of the opening stroke movement, forming a flow cross-section which leads to a calming of the flow and thus to a laminar inflow of fuel into the injection hole. This is achieved by the design of the nozzle needle tip, on the one hand, and the blind hole, on the other hand, the flow cross-section being fixed therebetween. Since it results in little or no pressure drop with the inflow of fuel into the injection hole, the formation of cavitation is prevented at this point, which could otherwise lead to the known cavitation damage in the region of the injection holes or the blind hole.

The partial stroke of the nozzle needle is, in particular, the region of the nozzle needle stroke in which the ratio of the seat cross-section area and the total injection hole cross-section is no more than 1.3. Only when the total injection hole cross-section is greater than 1.3 times the seat cross-section area is there the risk of the formation of cavitation in the blind hole, since then the injection holes form the smallest flow cross-section and, as a result, it does not lead to a pressure drop in the inflow of fuel from the pressure chamber into the blind hole. By the shaping of the sealing surface according to the invention, the tendency for cavitation in the partial stroke region of the nozzle needle is thus effectively prevented. Advantageously, the flow cross-section between the needle tip and the wall of the blind hole as far as the injection hole upper edge is at most twice the seat cross-section area, wherein the injection hole upper edge is the imaginary line which circulates around the blind hole and which is marked by the inlet edge of the injection holes facing the body seat in the wall of the blind hole.

In an advantageous embodiment of the invention, a shoulder is formed at the transition of the sealing surface of the nozzle needle to the needle tip, which, by interaction with the transition edge at the transition of the body seat to the blind hole, leads to an advantageous embodiment of the flow cross-section in this region.

In a further advantageous embodiment, a transition cone is configured on the nozzle needle between the needle tip and the sealing surface, the opening angle thereof being different from the opening angle of the sealing surface and the opening angle of the needle tip. Therefore, an optimization of the flow may also be achieved by interaction with the transition edge at the start of the blind hole, in order to adapt the nozzle needle to different embodiments of the injection hole or of the body seat.

In a further advantageous embodiment, the opening angle of the conical needle tip and the opening angle of the conical blind hole are of the same size. As a result, a uniform flow cross-section results between these components and thus an equalization of the flow. In this case, in a further advantageous embodiment, the diameter of the injection hole upper edge is larger than the diameter of the transition edge. As a result, it may be achieved that the flow cross-section between the nozzle needle and the wall of the blind hole is constant between the transition edge and the injection hole upper edge so that the equalization of the flow is achieved.

### BRIEF DESCRIPTION OF THE DRAWINGS

Various exemplary embodiments of the injection nozzle according to the invention are shown in the drawing, in which:

FIG. 1 shows an injection nozzle as known from the prior art in a longitudinal section,

FIG. 2 shows an enlargement of the blind hole known from the prior art with the nozzle needle and a definition of the geometric sizes,

FIG. 3 shows a nozzle also known from the prior art, wherein further flow cross-sections are defined herein,

FIG. 4 shows a first embodiment according to the invention of the injection nozzle according to the invention in the same view as in FIG. 2 and

FIGS. 5, 6, 7 and 8 show further exemplary embodiments of the invention.

### DETAILED DESCRIPTION

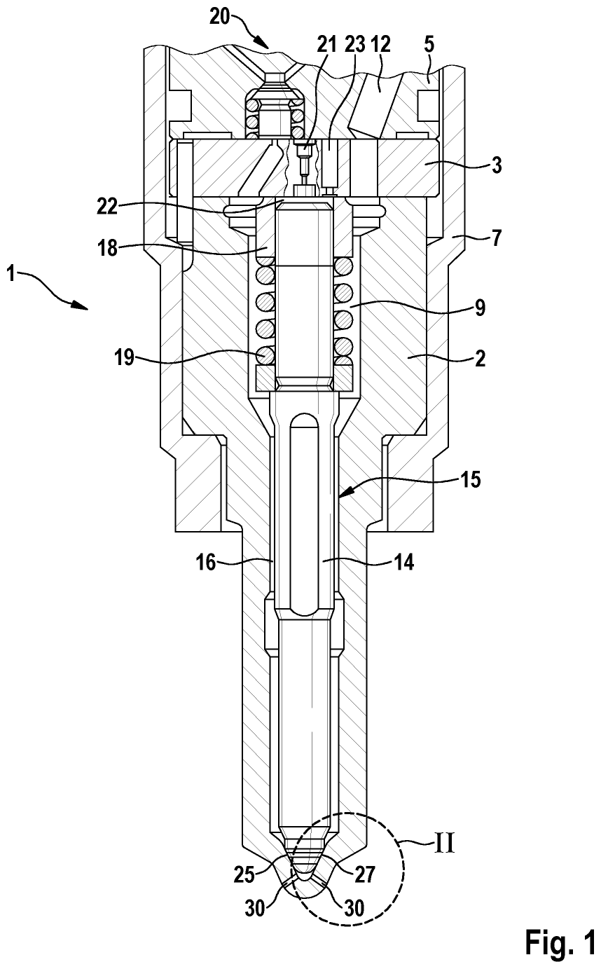

In FIG. 1 a fuel injector 1 is shown in longitudinal section, as is known from the prior art, wherein only the region of the injection nozzle of the fuel injector which is sufficient for the following description of the invention is shown. The injection nozzle has a nozzle body 2 which is clamped by the interposition of a throttle plate 3 in a fluid-tight manner by means of a clamping nut 7 against a holding body 5. A pressure chamber 9 is formed in the nozzle body 2, said pressure chamber being able to be filled with fuel at high pressure via a high-pressure bore 12 which is configured in the holding body 5 and the throttle plate 3. A piston-shaped nozzle needle 14 is arranged in the pressure chamber 9 so as to be longitudinally movable. The nozzle needle 14 in this case is guided in a guide portion 15 inside the pressure chamber 9, wherein the flow of fuel into this guide portion 15 is ensured by a plurality of polished sections 16 on the nozzle needle 14, which are configured to be sufficiently large that it does not result in the fuel flow being throttled in this region. A body seat 25 is formed at the end of the nozzle body 2 on the combustion chamber side in the pressure chamber 9, said body seat being conically shaped and interacting with a conical sealing surface 27 which is configured on the nozzle needle 14. A blind hole 32 adjoins the conical body seat 25, a plurality of injection holes 30, through which the fuel exits, emerging from said blind hole.

At the end remote from the combustion chamber, the nozzle needle 14 is guided in a sleeve 18. The sleeve 18 is pressed by a closing spring 19 surrounding the nozzle needle 14 against the throttle plate 3 and thus is held fixedly in this position. The nozzle needle 14, the sleeve 18 and the throttle plate 3 define a control chamber 22 which is connected via an inlet throttle 23 to the high-pressure bore 12. In order to control the pressure in the control chamber 22, the control chamber 22 may be connected via an outlet throttle 21 to a low pressure chamber in the holding body 5, not shown in more detail in the drawing. To this end, a control valve 20 is configured in the holding body 5, said control valve opening and closing this connection, driven by an electromagnetic actuator or piezo-electrical actuator. If an injection of fuel is intended to take place, the control valve 20 opens the connection of the control chamber 22 to the low pressure chamber by the outlet throttle 21 being opened up. Due to the pressure drop in the control chamber 22 the hydraulic closing force acting in the direction of the body seat 25 is reduced and the nozzle needle 14 is raised from the body seat 25 and opens up a flow cross-section between the sealing surface 27 and the body seat 25, through which fuel may flow out of the pressure chamber 9 into the blind hole 32 and from there to the injection openings 30. The fuel passes through the injection holes 30, is finely atomized at the same time and forms a combustible mixture together with the air in the combustion chamber. For terminating the fuel injection, the control valve 20 is closed again and the fuel flowing via the inlet throttle 23 from the high pressure bore 12 pushes the nozzle needle 14 back into its closed position, i.e. in contact with the body seat 25.

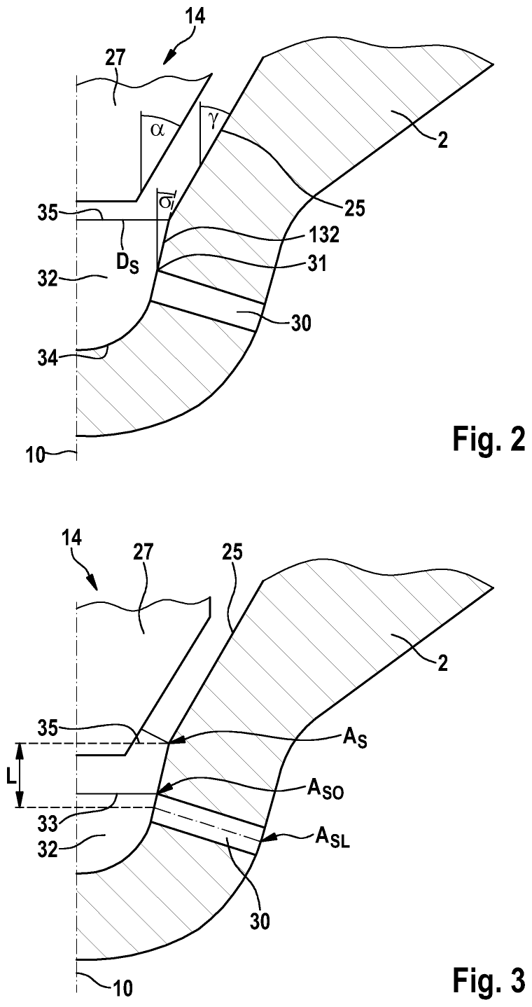

For the further explanation, FIG. 2 shows an enlarged view of the detail of FIG. 1 denoted by II. Since the nozzle body and also the nozzle needle 14 are configured to be rotationally symmetrical relative to a longitudinal axis 10, for the sake of clarity, only one side of the injection nozzle is shown here. The conical body seat 25 has an opening angle γ which is defined here as the angle between the longitudinal axis 10 and the body seat 25. The body seat 25 transitions into a blind hole 32, forming a transition edge 35, wherein the blind hole 32 has a conical portion 132 and is defined by a dome 34 at the end on the combustion chamber side. The opening angle of the conical blind hole 32 is denoted here by a and is significantly smaller than the opening angle γ of the body seat 25. The sealing surface 27 on the nozzle needle 14 is also conically configured and interacts with the body seat 25. The opening angle of the sealing surface 27 is denoted by a and in this exemplary embodiment is slightly larger than the opening angle γ of the body seat 25. The injection holes 30 are configured so as to be distributed over the circumference of the blind hole 32, for example five or six injection holes 30, wherein the injection holes 30 form an upper inlet edge 31, i.e. the region of the round inlet edge of the injection holes 30 which is closest to the body seat 25.

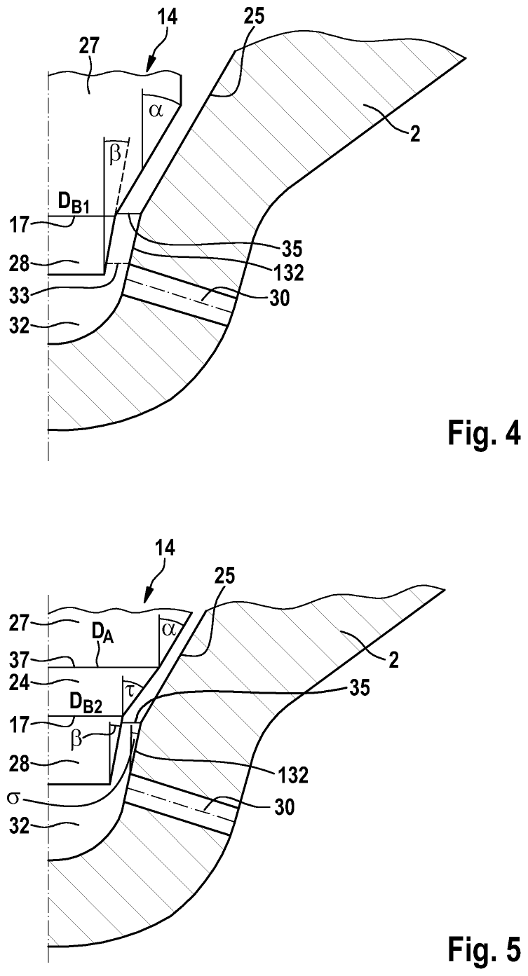

The flow of the fuel from the pressure chamber 9 into the blind hole 32 and onward into the injection holes 30 takes place through different flow cross-sections as shown in FIG. 3. The flow cross-section between the sealing surface 27 and the transition edge 35 forms a seat cross-section area A_{S}. This seat cross-section area A_{S} forms the smallest flow cross-section when the nozzle needle is located in a partial stroke, i.e. when it has been moved away only slightly from the body seat 25 at the start of the opening stroke movement. The fuel flows through the seat cross-section area A_{S} into the blind hole 32 and at the same time passes the surface A_{SO} which is formed by the injection hole upper edge 33. The injection hole upper edge 33 in this case is defined as the imaginary line on which the inlet edges 31 are located. This forms the flow cross-section before the fuel flows into the injection holes 30. All of the injection holes 30 together form a total injection hole cross-section A_{SL} so that the flow inside the blind hole 32 is determined, in particular, by the ratio of these flow cross-sections to one another. Moreover, other geometric sizes also influence the flow of fuel, in particular the so-called L-dimension, which is identified in FIG. 3 by L and which marks the distance from the transition edge 35 to the center of the injection holes 30. If the nozzle needle 14 has only performed a small part of its maximum opening stroke, the cross-section area A_{S} forms the smallest cross-section, whilst the surface of the injection upper edge A_{SO} accordingly is relatively large. Only when the nozzle needle 14 has exceeded a specific stroke does the total injection hole cross-section A_{SL} form the smallest flow cross-section, so that the fuel flow is decelerated only when entering the injection hole, which does not lead to cavitation in the blind hole 32.

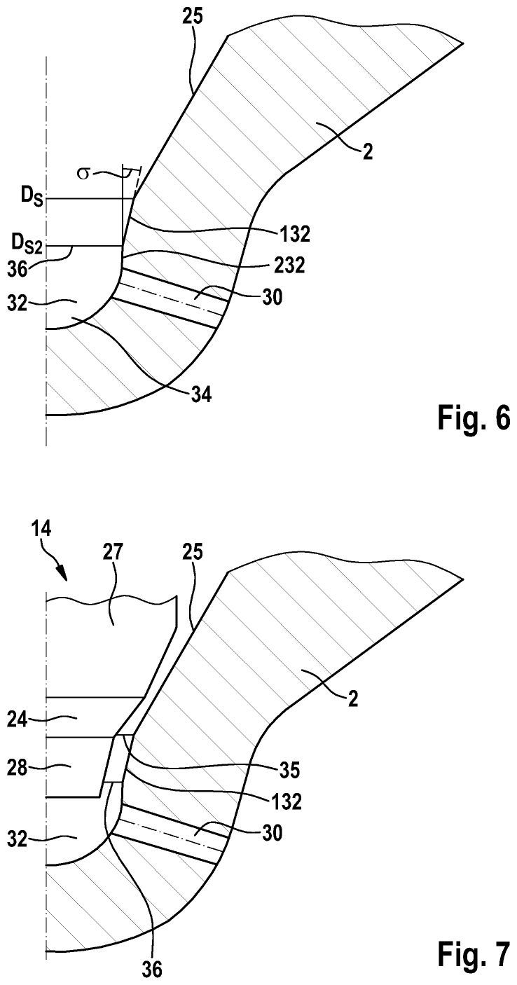

FIG. 4 shows a first exemplary embodiment of the injection nozzle according to the invention in the same view as FIG. 3. A needle tip 28 which protrudes into the blind hole 32 is configured on the nozzle needle 14 adjoining the conical sealing surface 27. The needle tip 28 is also conically configured and has an opening angle β which is smaller than the opening angle α of the sealing surface 27. In this exemplary embodiment, the opening angle β corresponds approximately to the opening angle σ of the blind hole wall so that a substantially constant flow cross-section is formed between the needle tip 28 and the wall of the blind hole 32. This flow cross-section extends as far as the height of the injection hole upper edge 33 so that an equalization of the flow is achieved in this region between the seat cross-section area A_{S} and the injection holes 30. Thus it does not lead to a pressure drop when the fuel enters the blind hole 32, and thus to no cavitation formation, at least a significant reduction in the tendency to cavitation, which prevents cavitation damage in the region of the blind hole 32 and the injection holes 30. For forming this flow cross-section, the diameter D_{B1} of the offset edge 17 which is formed between the sealing surface 27 and the needle tip 28 is smaller than the diameter D_{S} of the transition edge 35 (see FIG. 2) which marks the transition between the body seat 25 and the blind hole 32.

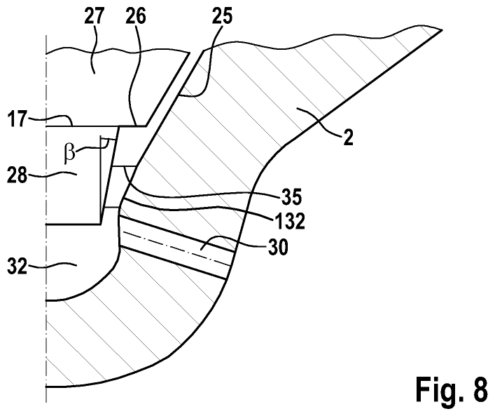

In FIG. 5 a further exemplary embodiment of the injection nozzle according to the invention is shown. Here a transition cone 24 is configured on the nozzle needle 14 between the sealing surface 27 and the needle tip 28. The opening angle β of the transition cone 24 is larger than the opening angle α of the sealing surface 27 and smaller than the opening angle β of the needle tip 28, so that an edge is also formed at the transition of the sealing surface 27 to the transition cone 24. The diameter D_{A} of this transition edge 37 between the sealing surface 27 and the transition cone 24 is larger than the diameter of the transition edge 35 in order to form the corresponding flow path to the injection holes 30.

FIG. 6 shows a further variant of the blind hole of an injection nozzle according to the invention. In this case, the injection hole 30 has a cylindrical portion 232 adjoining the conical portion 132, which is defined by the transition edge 35 and an intermediate edge 36, a rounded dome 34 adjoining said cylindrical portion. The interaction with the correspondingly shaped nozzle needle 14 is shown in FIG. 7. In this case, over a large part of the needle stroke the conical needle tip 28 is opposite the conical portion 132 of the blind hole 32 and thus forms the flow cross-section which leads to a calming of the flow. In particular, in this case a nozzle needle 14 which has a transition cone 24 between the sealing surface 27 and the needle tip 28 may be used. A further exemplary embodiment of the injection nozzle according to the invention is shown in FIG. 8. In this case, a shoulder 26 is configured at the transition of the sealing surface 27 to the needle tip 28, the offset edge 17 being formed thereby.

In the injection nozzle according to the invention, the corresponding angles and distances have to be matched such that during the partial stroke of the nozzle needle the seat cross-section area A_{S} is only slightly larger than the total injection hole cross-section AK so that no flow deceleration occurs when entering the blind hole 32, but only when entering the injection holes 30. In this case it is advantageous, in particular, if the diameter Dₛ of the transition edge 35 is larger than the diameter of the intermediate edge 36 and at most 1.6 times this diameter D_{S2}. It is also advantageous if the cone angle β of the needle tip 28 is in the region of +/−20° of the opening angle σ of the conical portion 132 of the blind hole 32.

1. An injection nozzle for injecting fuel under high pressure, the injection nozzle comprising
a nozzle body (2) in which a pressure chamber (9), that is configured to be filled with fuel under high pressure, is formed and in which a conical body seat (25) is formed, wherein the body seat (25) opens into a blind hole (32), forming a transition edge (35), wherein a plurality of injection holes (30) originate from the blind hole and a total of flow cross-sections of all of the injection holes forms a total injection hole cross-section (A_{SL}), and
a nozzle needle (14) which is arranged in the pressure chamber (9) so as to be longitudinally movable, and which interacts, via a conical sealing surface (27), with the body seat (25) in order to open and close a flow cross-section between the sealing surface (27) and the body seat (25), wherein the nozzle needle (14) has, on the an thereof facing the body seat (25), a needle tip (28) which protrudes into the blind hole (32) when the sealing surface (27) contacts the body seat (25), wherein a seat cross-section area (A_{S}) is formed between the sealing surface (27) and the transition edge (35) when the nozzle needle (14) is raised from the body seat (25), through which seat cross-section area fuel can flow from the pressure chamber (9) into the blind hole (32),
wherein the needle tip (28) is conical and has an opening angle (β) that is smaller than an opening angle (α) of the conical sealing surface (27), and the blind hole (32) has a conical portion (132) having an opening angle (σ) which adjoins the transition edge (35), wherein the needle tip (28) is arranged in a partial stroke of the nozzle needle (14) at a height of the conical portion (132) of the blind hole (32).

2. The injection nozzle as claimed in claim 1, characterized in that the partial stroke of the nozzle needle (14) is a needle stroke region in which a ratio of the seat cross-section area (A_{S}) and the total injection hole cross-section (A_{SL}) is no more than 1.3 (A_{S}/A_{SL}≤1.3).

3. The injection nozzle as claimed in claim 2, characterized in that a flow cross-section between the needle tip (28) and a wall of the blind hole (32) as far as an injection hole upper edge (33) is at most twice the seat cross-section area (As), wherein the injection hole upper edge (33) is an imaginary line which circulates around the blind hole (32) and which is marked by an inlet edge of the injection holes (30) facing the body seat (25) in the wall of the blind hole (32).

4. The injection nozzle as claimed in claim 1, characterized in that a shoulder (26) is formed at a transition of the sealing surface (27) to the needle tip (28).

5. The injection nozzle as claimed in claim 1, characterized in that a transition cone (24) is configured on the nozzle needle (14) between the needle tip (28) and the sealing surface (27), an opening angle (τ) of the transition cone being different from the opening angle (a) of the sealing surface (27) and the opening angle (β) of the needle tip (28).

6. The injection nozzle as claimed in claim 1, characterized in that the opening angle (β) of the conical needle tip (28) and the opening angle (σ) of the conical blind hole (32) are of the same size.

7. The injection nozzle as claimed in claim 1, characterized in that a diameter (A_{SO}) of the injection hole upper edge (33) is larger than a diameter (D_{S}) of the transition edge (35).

8. The injection nozzle as claimed in claim 1, characterized in that a flow cross-section between the nozzle needle (14) and the wall of the blind hole (32) is constant between the transition edge (35) and the injection hole upper edge (33).

9. The injection nozzle as claimed in claim 1, characterized in that a cylindrical portion or a dome (34) adjoins the conical portion (132) in the blind hole (32).

10. The injection nozzle as claimed in claim 3, characterized in that a shoulder (26) is formed at a transition of the sealing surface (27) to the needle tip (28).

11. The injection nozzle as claimed in claim 3, characterized in that a transition cone (24) is configured on the nozzle needle (14) between the needle tip (28) and the sealing surface (27), an opening angle (τ) of the transition cone being different from the opening angle (α) of the sealing surface (27) and the opening angle (β) of the needle tip (28).
